(19) United States
(12) Patent Application Publication
(10) Pub. No.: US 2026/0155507 A1
(43) Pub. Date: Jun. 4, 2026

(54) CASE FOR SECONDARY BATTERY AND SECONDARY BATTERY INCLUDING CASE

(71) Applicant: SAMSUNG SDI CO., LTD., Yongin-si (KR)

(72) Inventor: Dong Bok YANG, Yongin-si (KR)

(21) Appl. No.: 19/341,781

(22) Filed: Sep. 26, 2025

(30) Foreign Application Priority Data
Dec. 4, 2024 (KR) 10-2024-0178440

(51) Int. Cl. H01M 50/169; H01M 10/052; H01M 50/103; H01M 50/119; H01M 50/15; H01M 50/159; H01M 50/55

(52) U.S. Cl. CPC H01M 50/169; H01M 10/052; H01M 50/103; H01M 50/119; H01M 50/15; H01M 50/159; H01M 50/55

(57) ABSTRACT

The present disclosure provides a case for a secondary battery, and a secondary battery. The case includes: a body including an accommodation portion having an open end and a flange portion extending around the open end; a cover configured to be coupled to the flange portion to seal the open end; and a welded portion coupling the flange portion and the cover, wherein the welded portion includes a first welding bead and a second welding bead having different bonding forces.

### CROSS-REFERENCE TO RELATED APPLICATION

The present application claims priority to and the benefit of Korean Application No. 10-2024-0178440, filed on Dec. 4, 2024, in the Korean Intellectual Property Office, the entire disclosure of which is incorporated by reference herein.

### BACKGROUND

### Field

The present disclosure relates to a case for a secondary battery, and a secondary battery including the case.

### Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Secondary batteries may be exposed to high-temperature environments or become short-circuited. Swelling may occur as gas is generated inside the case due to decomposition of the electrolyte solution and/or detrimental reactions happening at the electrode, causing the secondary battery case to rupture, resulting in fire or explosion due to thermal runaway.

This Background section is for the general understanding of the background of the present disclosure, and therefore, it may contain information that does not constitute related (or prior) art.

### SUMMARY

The present disclosure is drawn to a case for a secondary battery capable of preventing thermal runaway due to an increase in internal pressure resulting from the non-ideal behavior of the secondary battery. The present disclosure is also drawn to a secondary battery including the case.

These and other aspects and features of the present disclosure will be described in or will be apparent from the following description of embodiments of the present disclosure.

According to embodiments of the present disclosure, there is provided a case for a secondary battery, a case for a secondary battery includes a body including an accommodation portion having one open end for accommodating an electrode assembly, and a flange portion extending around an open end of the accommodation portion, a cover configured to be welded and coupled to the flange portion to seal the open end of the accommodation portion, and a welded portion including the flange portion and a welded and coupled part of the cover, in which the welded portion includes at least one first welding bead and at least one second welding bead having different bonding forces.

Embodiments of the present disclosure provide a case including: a body including an accommodation portion having an open end and a flange portion extending around the open end; a cover configured to be coupled to the flange portion to seal the open end; and a welded portion coupling the flange portion and the cover, wherein the welded portion includes a first welding bead and a second welding bead having different bonding forces.

According to embodiments of the present disclosure, a bonding force of the second welding bead may be less than a bonding force of the first welding bead.

According to embodiments of the present disclosure, the second welding bead may be breakable when a pressure equal to or greater than a critical value is generated inside the case.

In some embodiments, the second welding bead is configured to break upon an internal pressure of the case exceeding a predetermined threshold.

According to embodiments of the present disclosure, a number of the second welding bead may be less than a number of the first welding bead.

According to embodiments of the present disclosure, each of the first welding bead and the second welding bead may be formed to overlap with an adjacent welding bead at least one point.

In some embodiments, each of the first welding bead and the second welding bead overlaps with an adjacent welding bead.

According to embodiments of the present disclosure, the first welding bead and the second welding bead may have an arc geometry, and a central angle of an arc of the second welding bead may be less than or equal to a central angle of an arc of the first welding bead.

According to embodiments of the present disclosure, the first welding bead may have an arc geometry with a central angle of 360 degrees, and the second welding bead may have an arc geometry with a central angle of 180 degrees.

In some embodiments, the central angle of the arc of the first welding bead is about 360 degrees, and wherein the central angle of the arc of the second welding bead is about 180 degrees.

According to embodiments of the present disclosure, a radius of the arc of the second welding bead may be less than or equal to a radius of the arc of the first welding bead.

According to embodiments of the present disclosure, a radius of the arc of the second welding bead may be about 50% of a radius of the arc of the first welding bead.

According to embodiments of the present disclosure, a radius of the arc of the first welding bead may be about 0.1 mm, and a radius of the arc of the second welding bead may be about 0.05 mm.

According to embodiments of the present disclosure, based on a direction in which the flange portion and the cover are stacked, a length of the second welding bead may be less than a length of the first welding bead.

According to embodiments of the present disclosure, based on a direction in which the flange portion and the cover are stacked, the length of the first welding bead may correspond to 90% to 100% of a sum of a thickness of the flange portion and a thickness of the cover.

In some embodiments, the length of the first welding bead is about 90% to about 100% of a sum of a thickness of the flange portion and a thickness of the cover.

According to embodiments of the present disclosure, the first welding bead and the second welding bead may include an arc geometry with a central angle of 180 degrees.

In some embodiments, both the central angle of the arc of the first welding bead and the central angle of the arc of the second welding bead are about 180 degrees.

According to embodiments of the present disclosure, a radius of the arc of the second welding bead may be less than or equal to a radius of the arc of the first welding bead.

According to embodiments of the present disclosure, based on a direction in which the flange portion and the cover are stacked, a length of the second welding bead may be less than a length of the first welding bead.

According to embodiments of the present disclosure, at least one of the body and the cover may include stainless steel.

According to embodiments of the present disclosure, there is provided a secondary battery, a secondary battery includes an electrode assembly including a first electrode, a second electrode, and a separator disposed between the first electrode and the second electrode, and a case in which the electrode assembly is accommodated, in which the case includes a body including a accommodation portion having one open end for accommodating an electrode assembly, and a flange portion extending around an open end of the accommodation portion, a cover configured to be welded and coupled to the flange portion to seal the open end of the accommodation portion, and a welded portion including the flange portion and a welded and coupled part of the cover, and the welded portion includes at least one first welding bead and at least one second welding bead having different bonding forces.

Embodiments of the present disclosure provide a secondary battery including: an electrode assembly including a first electrode, a second electrode, and a separator disposed between the first electrode and the second electrode; and a case in which the electrode assembly is accommodated, wherein the case includes: a body including an accommodation portion having an open end and a flange portion extending around the open end; a cover configured to be coupled to the flange portion to seal the open end; and a welded portion coupling the flange portion and the cover, wherein the welded portion includes a first welding bead and a second welding bead having different bonding forces.

According to embodiments of the present disclosure, a bonding force of the second welding bead may be less than a bonding force of the first welding bead.

According to embodiments of the present disclosure, the body may further include a first electrode terminal configured to be disposed on one side surface of the body and electrically connected to the first electrode, and a second electrode terminal configured to be disposed on one side surface of the body and electrically connected to the second electrode.

In some embodiments, the body further includes: a first electrode terminal disposed on one side surface of the body, the first electrode terminal electrically connected to the first electrode; and a second electrode terminal disposed on one side surface of the body, the second electrode terminal electrically connected to the second electrode.

According to embodiments of the present disclosure, the first electrode terminal and the second electrode terminal may protrude in a first direction from the accommodation portion, the flange portion may include a first flange portion extending in the first direction from the accommodation portion, a second flange portion and a third flange portion extending in a second direction perpendicular to the first direction from the accommodation portion, and a fourth flange portion extending in an opposite direction of the first flange portion from the accommodation portion, and the second welding bead may be formed in the first flange portion to the third flange portion.

In some embodiments, wherein the first electrode terminal and the second electrode terminal protrude in a first direction from the accommodation portion, wherein the flange portion includes: a first flange portion extending in the first direction; a second flange portion and a third flange portion both extending in a second direction perpendicular to the first direction; and a fourth flange portion extending in a direction opposite to the first direction, and wherein the second welding bead is formed on the first flange portion, the second flange portion, and the third flange portion

According to some embodiments of the present disclosure, a case for a secondary battery, and a secondary battery including the same may be provided, which may prevent thermal runaway due to an increase in internal pressure resulting from abnormal behavior of the secondary battery without a separate additional process.

According to some embodiments of the present disclosure, in the process of welding and joining a body and a cover in which an electrode assembly of a secondary battery is accommodated, a vent may be formed by only partially changing the pattern of the welded portion.

According to some embodiments of the present disclosure, the energy density of a secondary battery may be improved by reducing the width of a welding bead and thereby reducing the width of a flange portion.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 is an exploded perspective view showing a case for a secondary battery according to embodiments of the present disclosure.

FIG. 2 is a cross-sectional view showing a case for a secondary battery and a welded portion of the case for a secondary battery according to embodiments of the present disclosure.

FIG. 3 is a plan view showing a case for a secondary battery including a first welding bead and a second welding bead having different geometries according to embodiments of the present disclosure.

FIGS. 4A and 4B are cross-sectional views showing a case for a secondary battery including a first welding bead and a second welding bead having the same welding depth according to embodiments of the present disclosure.

FIG. 5 is a plan view showing a case for a secondary battery including a first welding bead and a second welding bead having different geometries and radii according to embodiments of the present disclosure.

FIGS. 6A and 6B are cross-sectional views showing a case for a secondary battery including a first welding bead and a second welding bead having different welding depths according to embodiments of the present disclosure.

FIG. 7 is a plan view showing a case for a secondary battery including a first welding bead and a second welding bead having the same geometry according to embodiments of the present disclosure.

FIGS. 8A and 8B are cross-sectional views showing a case for a secondary battery including a first welding bead and a second welding bead having different welding depths according to embodiments of the present disclosure.

FIG. 9 is a plan view showing a case for a secondary battery including a first welding bead and a second welding bead having different radii according to embodiments of the present disclosure.

FIGS. 10A and 10B are cross-sectional views showing a case for a secondary battery including a first welding bead and a second welding bead having the same depth according to embodiments of the present disclosure.

FIG. 11 is an exploded perspective view showing a secondary battery according to embodiments of the present disclosure.

FIG. 12 is a flowchart illustrating a method for manufacturing a secondary battery according to embodiments of the present disclosure.

FIG. 13 shows a step of welding a case for a secondary battery according to embodiments of the present disclosure.

FIG. 14 shows a step of cutting a flange portion according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

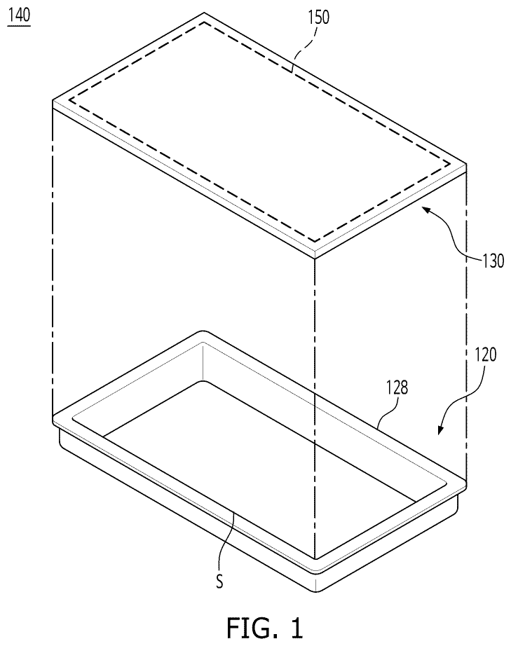

FIG. 1 is an exploded perspective view showing a case for a secondary battery.

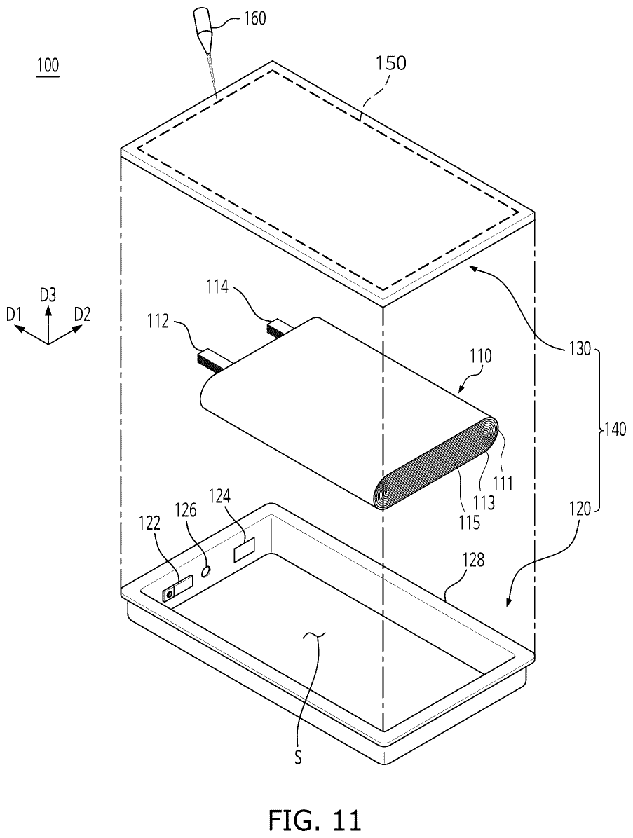

Referring to FIG. 1, a case 140 for a secondary battery may include a body 120, which includes an accommodation portion S for accommodating an electrode assembly 110 (see FIG. 11) and a flange portion 128 extending around an open end of the accommodation portion S, a cover 130 welded to the flange portion 128 to seal the open end of the accommodation portion S, and a welded portion 150 including a welded portion of the flange portion 128 and the cover 130.

The case 140 forms the overall appearance of the secondary battery and may include a conductive metal such as aluminum, an aluminum alloy, or nickel-plated steel. The body 120 and the cover 130 may be composed of the same metallic material. The metallic material may include stainless steel or aluminum Al. However, the case 140 may include various metallic materials that satisfy the strength and resistance requirements for external impact required for the secondary battery.

The body 120 may include an accommodation portion S with one side open to receive the electrode assembly 110. The accommodation portion S of the body 120 may have an internal space in which the electrode assembly 110 is received by press processing or the like. The planar geometry of the accommodation portion S of the case 140 may have various geometries depending on the geometry of the press device. For example, the planar geometry of the accommodation portion S may have a rectangular geometry. However, the planar geometry of the accommodation portion S is not limited to this example.

The cover 130 may be welded to the flange portion 128 of the body 120 to seal the open end of the accommodation portion S. For example, the cover 130 may be formed as a flat plate having a size sufficient to cover the flange portion 128 and may be in surface contact with the flange portion 128. That is, the lower surface of the cover 130 and the upper surface of the flange portion 128 may be disposed to make surface contact with each other. By combining the flange portion 128 and the cover 130, the body 120 and the cover 130 may form a single structure. In an embodiment, the body 120 may be joined to the cover 130 by laser welding. However, the bonding method is not limited to this embodiment, and various bonding methods may be employed capable of sealing the case 140. For example, the cover 130 and the flange portion 128 may be joined by laser welding as well as ultrasonic welding, brazing, laser brazing, welding, soldering, etc.

The welded portion 150 may refer to a region where the flange portion 128 and the cover 130 are joined to each other to seal the accommodation portion S. As illustrated in FIG. 1, the welded portion 150 may be formed along the flange portion 128, and the edge of a cover 130 corresponding to the flange portion 128. However, the location of the welded portion 150 is not limited to the location shown in FIG. 1 and may be formed in various locations.

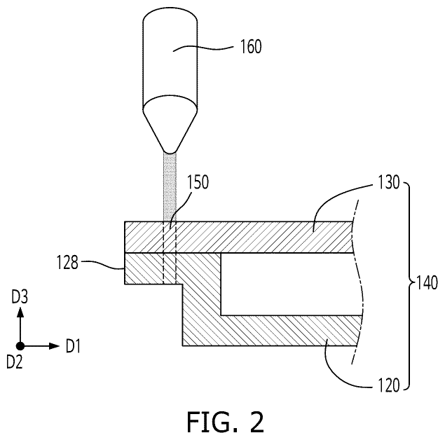

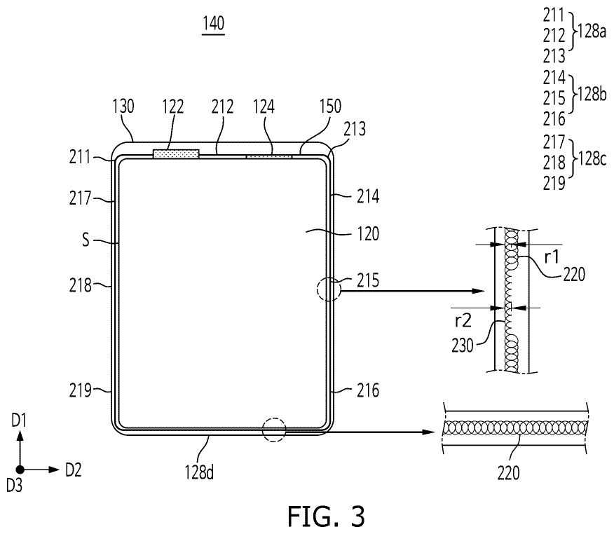

The welded portion 150 may include a first welding bead 220 (see FIG. 3) and a second welding bead 230 (see FIG. 3) having different bonding forces. In an embodiment, the bonding force of the second welding bead 230 may be less than the bonding force of the first welding bead 220. In an embodiment, the second welding bead 230 may be ruptured when a pressure greater than a predetermined threshold is applied within the case 140. A thermal runaway may occur caused by an increase in internal pressure due to the non-ideal behavior of the secondary battery 100. The second welding bead 230 may break, thereby reducing the internal pressure of the case 140 (or the accommodation portion S). The second welding bead 230 may be formed at any location among the locations where the welded portion 150 is formed. This is described in more detail later with reference to FIGS. 2 to 11.

FIG. 2 is a cross-sectional view showing a case for a secondary battery and a welding portion of the case for a secondary battery.

Referring to FIG. 2, the body 120 and the cover 130 of the secondary battery may be welded to form a case 140 which is a single joint structure. The edge or outermost area of the cover 130 may be welded to the flange portion 128 of the body 120 using a welding machine 160. For example, the cover 130 and the flange portion 128 may be welded together through laser welding. The case 140 may include a welded portion 150 in which the flange portion 128 and the cover 130 are welded to each other.

The welded portion 150 may be formed via welding of the cover 130 and the flange portion 128. The welded portion 150 may be formed on the surface between the body 120 and the cover 130 by laser welding. The welded portion 150 may have different bonding strengths depending on the welded portion or location. The welding machine 160 may be controlled to create welding beads having different bonding strengths at different locations in the welded portion 150.

However, the bonding method is not limited to the embodiment, and various bonding methods may be employed capable of sealing the case 140. For example, the cover 130 and the flange portion 128 may be joined by laser welding as well as ultrasonic welding, brazing, laser brazing, welding, soldering, etc.

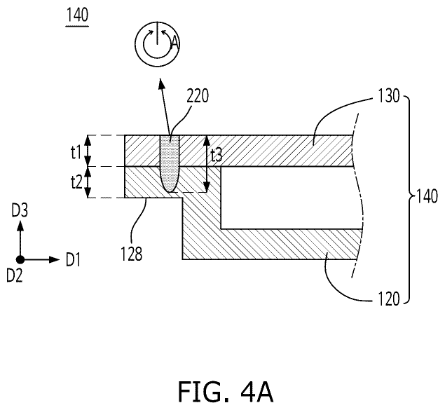

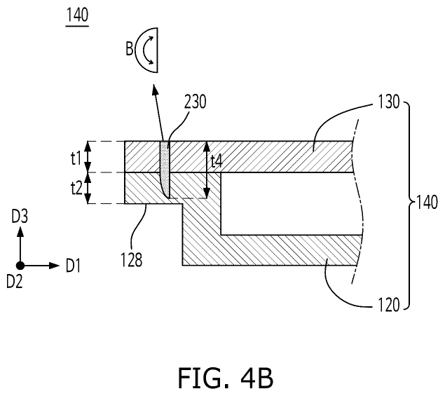

FIG. 3 is a plan view showing a secondary battery case including a first welding bead and a second welding bead having different geometries, and FIGS. 4A and 4B are cross-sectional views showing a secondary battery case including a first welding bead and a second welding bead having the same welding depth.

FIG. 4A shows the welding depth of the first welding bead 220, and FIG. 4B shows the welding depth of the second welding bead 230.

Referring to FIGS. 3, 4A, and 4B, the case 140 may include a body 120, a cover 130 and a welded portion 150. The body 120 may include an accommodation portion S and a flange portion 128. The welded portion 150 may be formed by welding along the edge or outermost area of the flange 128 and the cover 130. The welded portion 150 may include a first weld bead 220 and a second weld bead 230 having different bonding forces.

According to an embodiment, the body 120 may include a first electrode terminal 122 and a second electrode terminal 124 disposed on one side surface of the body 120. The first electrode terminal 122 and the second electrode terminal 124 may protrude in the first direction (D1 direction) from the accommodation portion S. The flange portion 128 may include a first flange portion 128a extending from the accommodation portion S in a first direction (D1 direction), a second flange portion 128b and a third flange portion 128c extending from the accommodation portion S in a second direction (D2 direction) perpendicular to the first direction D1 direction, and a fourth flange portion 128d extending from the accommodation portion S in an opposite direction to the first flange portion 128a.

According to an embodiment, the second welding bead 230 may be formed on the first flange portion 128a to the third flange portion 128c. The first flange portion 128a may include a first position 211, a second position 212, and a third position 213. The second flange portion 128b may include a fourth position 214, a fifth position 215, and a sixth position 216. The third flange portion 128c may include a seventh position 217, an eighth position 218, and a ninth position 219.

In an embodiment, the seconding weld bead 230 may be ruptured when a pressure equal to or greater than a predetermined threshold is applied within the case 140. The case 140 of the secondary battery may have a vertically long rectangular geometry, and the case 140 may swell from the center. The second welding bead 230 formed at the fifth position 215 or the eighth position 218 may break at a lower internal pressure than other positions. In cases where the second welding bead 230 is formed on the first position 211, the second position 212, and the third position 213, the first and second electrode terminals 122 and 124 positioned in proximity thereto may be damaged if the second welding bead 230 breaks. When the second welding bead 230 is formed on the fifth position 215 or the eighth position 218, thermal runaway may be prevented more effectively, compared to when the second welding bead 230 is formed at a different position.

In an embodiment, the number of second welding beads 230 may be less than the number of first welding beads 220. The remaining portion of the welded portion 150 excluding the second welding bead 230 includes the first welding bead 220. The bonding force of the second welding bead 230 may be less than the bonding force of the first welding bead 220.

According to an embodiment, each of the first welding bead 220 and the second welding bead 230 may be formed to overlap with an adjacent welding bead at at least one point. The welded portion 150 is formed continuously at the flange portion 128 and the cover 130 to seal the accommodation portion S of the body 120, thereby preventing moisture from penetrating from the exterior environment into the case 140.

According to an embodiment, the first welding bead 220 and the second welding bead 230 may include an arc geometry. The central angle B of the arc of the second welding bead 230 may be less than the central angle A of the arc of the first welding bead 220. The first welding bead 220 may include an arc geometry with a central angle A of about 360 degrees, and the second welding bead 230 may include an arc geometry with a central angle B of about 180 degrees. That is, the first welding bead 220 may include a circular geometry, and the second welding bead 230 may include a semicircular geometry. In this manner, the bonding force of the second welding bead 230 is less than that of the first welding bead 220, so that the second welding bead 230 may break before the first welding bead 220 does when a pressure exceeding a predetermined threshold develops within the case 140. Gas generated within the case 140 is discharged to the exterior environment, thereby improving the safety of the secondary battery.

In an embodiment, the radius r2 of the arc of the second welding bead 230 may be substantially equal to the radius r1 of the arc of the first welding bead 220. The distance from the center of the circle constituting the arc of the second welding bead 230 to the boundary of the arc may be substantially the same as the distance from the center of the circle constituting the arc of the first welding bead 220 to the boundary of the arc.

According to an embodiment, the length t4 of the second welding bead 230 may be less than or equal to the length t3 of the first welding bead 220, based on the direction in which the flange portion 128 and the cover 130 are laminated (D3 direction). As used herein, the length of the welding bead based on the direction in which the flange portion 128 and the cover 130 are laminated (D3 direction) may be referred to as the welding depth.

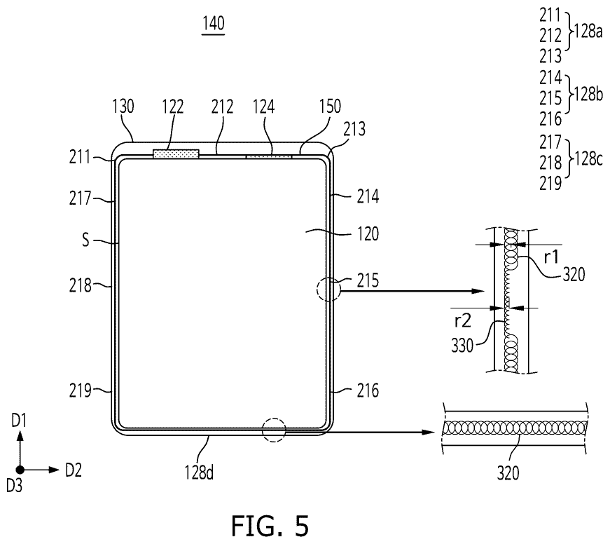

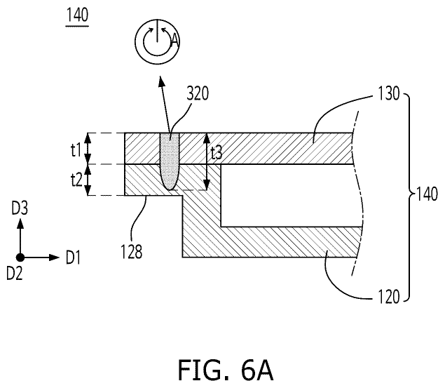

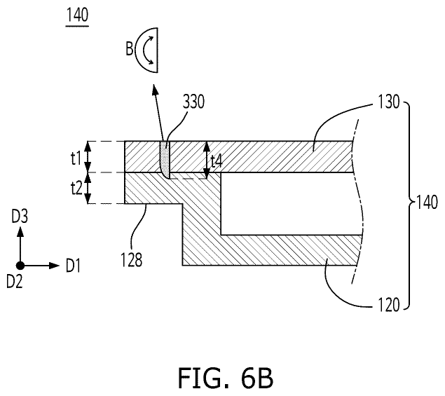

FIG. 5 is a plan view showing a secondary battery case including a first welding bead and a second welding bead having different geometries and radii, and FIGS. 6A and 6B are cross-sectional views showing a secondary battery case including a first welding bead and a second welding bead having different welding depths. FIG. 6A shows the welding depth of a first welding bead 320, and FIG. 6B shows the welding depth of a second welding bead 330.

Referring to FIGS. 5, 6A, and 6B, the first welding bead 320 may include an arc geometry with a central angle A of 360 degrees, and the second welding bead 330 may include an arc geometry with a central angle B of 180 degrees.

In an embodiment, the radius r2 of the arc of the second welding bead 330 may be less than the radius r1 of the arc of the first welding bead 320. The radius r2 of the arc of the second welding bead 330 may be about 50% of the radius r1 of the arc of the first welding bead 320. For example, the radius r1 of the arc of the first welding bead 320 may be about 0.1 mm, and the radius r2 of the arc of the second welding bead 330 may be about 0.05 mm. In this manner, the bonding force of the second welding bead 330 is less than that of the first welding bead 320, so that the second welding bead 330 may break before the first welding bead 320 does when a pressure exceeding a predetermined threshold develops within the case 140. Gas generated within the case 140 is discharged to the exterior environment, thereby improving the safety of the secondary battery.

According to an embodiment, the length t4 of the second welding bead 330 may be less than the length t3 of the first welding bead 320, based on the direction D3 in which the flange portion 128 and the cover 130 are laminated. Based on the direction (D3 direction) in which the flange portion 128 and the cover 130 are laminated, the length t3 of the first welding bead 320 may be about 90% to about 100% of the total sum (t1+t2) of the thickness t2 of the flange portion 128 and the thickness t1 of the cover 130. However, the welding depth of the second welding bead 330 is not limited thereto, and may be substantially the same as the welding depth of the first welding bead 320.

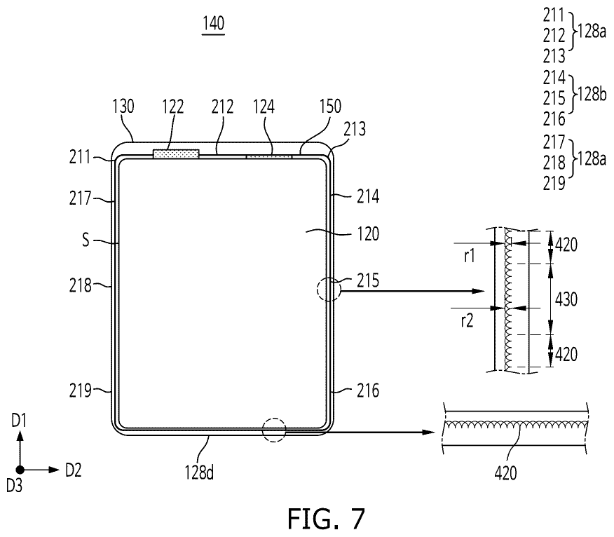

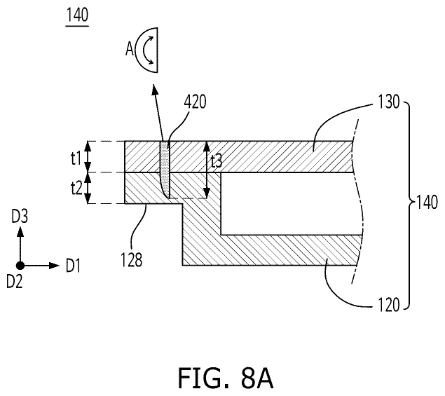

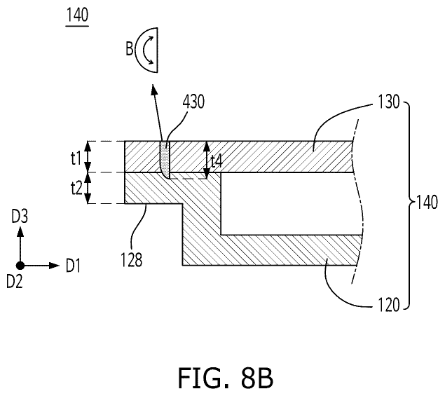

FIG. 7 is a plan view showing a secondary battery case including a first welding bead and a second welding bead having the same geometry, and FIGS. 8A and 8B are cross-sectional views showing a secondary battery case including a first welding bead and a second welding bead having different welding depths. FIG. 8A shows the welding depth of a first welding bead 420, and FIG. 8B shows the welding depth of a second welding bead 430.

Referring to FIGS. 7, 8A, and 8B, the first welding bead 420 and the seconding weld bead 430 may include an arc geometry with a central angle A or B of about 180 degrees. In an embodiment, the radius r2 of the arc of the second welding bead 430 may be substantially equal to the radius r1 of the arc of the first welding bead 420. In this manner, the energy density of the secondary battery may be improved by reducing the width of the welding bead 420, 430 and reducing the width of the flange portion 128. The energy density may refer to the amount of energy that may be stored per unit volume.

According to an embodiment, the length t4 of the second welding bead 430 may be less than the length t3 of the first welding bead 420, based on the direction in which the flange portion 128 and the cover 130 are laminated (D3 direction). Based on the direction in which the flange portion 128 and the cover 130 are laminated (D3 direction), the length t3 of the first welding bead 4200 may be about 90% to about 100% of the total sum (t1+t2) of the thickness t2 of the flange portion 128 and the thickness t1 of the cover 130. In the manner, the bonding force of the second welding bead 430 is less than that of the first welding bead 420, so that the second welding bead 430 may break before the first welding bead 420 does when a pressure exceeding a predetermined threshold develops within the case 140. Gas generated inside the case 140 is discharged to the exterior environment, thereby improving the safety of the secondary battery.

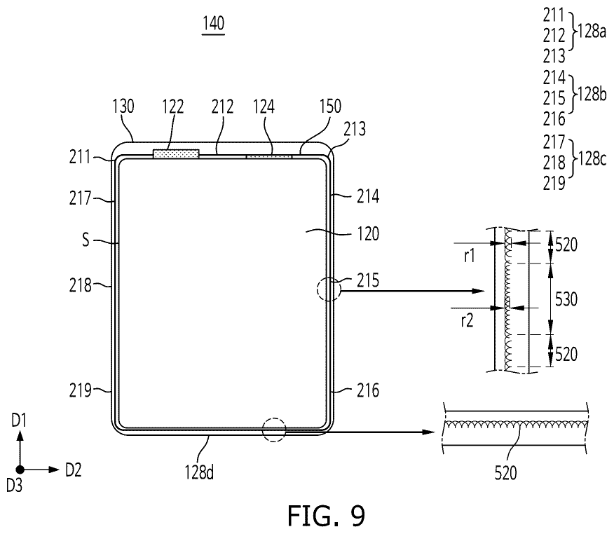

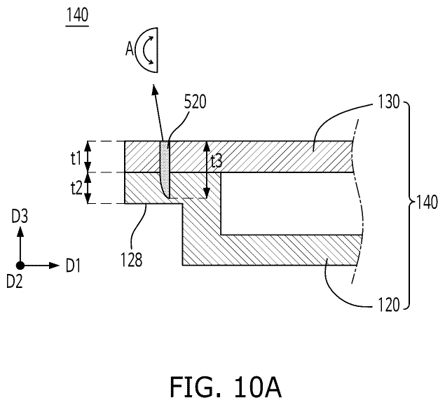

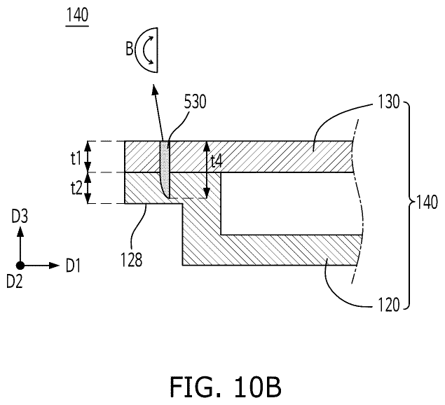

FIG. 9 is a plan view showing a case for a secondary battery including a first welding bead and a second welding bead having different radii, and FIGS. 10A and 10B are cross-sectional views showing a case for a secondary battery including a first welding bead and a second welding bead having the same depth. FIG. 10A shows the welding depth of a first welding bead 520, and FIG. 10B shows the welding depth of a second welding bead 530.

Referring to FIGS. 9, 10A, and 10B, the first welding bead 520 and the second welding bead 530 may include an arc geometry with a central angle A or B of about 180 degrees. In this manner, the energy density of the secondary battery may be improved by reducing the width of the welding bead 520 530 and reducing the width of the flange portion 128.

In an embodiment, the radius r2 of the arc of the second welding bead 530 may be less than the radius r1 of the arc of the first welding bead 520. In this manner, the bonding force of the second welding bead 530 is less than that of the first welding bead 520, so that the second welding bead 530 may break before the first welding bead 520 does when a pressure exceeding a predetermined threshold develops within the case 140. Gas generated inside the case 140 is discharged to the exterior environment, thereby improving the safety of the secondary battery.

According to an embodiment, the length t4 of the second welding bead 530 may be substantially equal to the length t3 of the first welding bead 520, based on the direction in which the flange portion 128 and the cover 130 are laminated (D3 direction). However, the welding depth of the second welding bead 530 is not limited thereto, and may be less than the welding depth of the first welding bead 520.

FIG. 11 is an exploded perspective view showing a secondary battery.

Referring to FIG. 11, a secondary battery 100 may include an electrode assembly 110 including a first electrode 111, a second electrode 113, and a separator 115 disposed between the first electrode 111 and the second electrode 113, and a case 140 in which the electrode assembly 110 is accommodated.

According to an embodiment, the electrode assembly 110 may be formed by sequentially winding or laminating a first electrode 111, a separator 115, and a second electrode 113. For example, the electrode assembly 110 is formed into a jelly roll configuration by sequentially winding a first electrode 111, a separator 115, and a second electrode 113. A cavity may be formed at the interior (core) of the jelly roll.

The first electrode 111 may be electrically connected to the first electrode tab 112, and the second electrode 113 may be electrically connected to the second electrode tab 114. The first electrode 111 may be a positive electrode or a negative electrode in the electrode assembly 110. The second electrode 113 may have a polarity opposite to that of the first electrode 111. For example, if the first electrode 111 is a positive electrode, the first electrode tab 112 may be a positive electrode tab, and if the second electrode 113 is a negative electrode, the second electrode tab 114 may be a negative electrode tab. If the first electrode 111 is a negative electrode, the first electrode tab 112 may be a negative electrode tab, and if the second electrode 113 is a positive electrode, the second electrode tab 114 may be a positive electrode tab.

The electrode assembly 110 may be impregnated with an electrolyte solution (not shown). Here, the electrolyte solution may be, for example, a liquid electrolyte solution, a solid electrolyte solution, a gel electrolyte solution or a combination thereof.

Each of the positive electrode and the negative electrode may include a current collector made of a thin metal foil having a coated portion on which an active material is coated and an uncoated portion on which an active material is not coated.

The positive electrode and the negative electrode are wound after interposing the separator, which is an insulator, therebetween. However, the present disclosure is not limited thereto, and the electrode assembly may have a structure in which a positive electrode and a negative electrode, each made of a plurality of sheets, are alternately stacked with a separator interposed therebetween.

A positive electrode for a rechargeable lithium battery may include a current collector and a positive electrode active material layer on the current collector.

The positive electrode active material layer may include a positive electrode active material and may include a binder and/or a conductive material (e.g., an electrically conductive material).

For example, the positive electrode may include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles to one another and also to attach the positive electrode active material to the current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, or the like.

The conductive material ensures conductivity (e.g., electrical conductivity) to the electrode. Any material that does not cause a detrimental chemical change (e.g., does not cause an undesirable chemical change in the rechargeable lithium battery) and conducts electrons can be used in the battery.

Non-limiting examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, or the like.

The negative electrode for a rechargeable lithium battery may include a current collector and a negative electrode active material layer on the current collector.

The negative electrode active material layer may include a negative electrode active material, and may include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles to one another and also to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, or a combination thereof.

When an aqueous binder is used as the negative electrode binder, a cellulose-based compound capable of imparting viscosity may be included. The cellulose-based compound may include carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may include polytetrafluoroethylene, polyvinylidene fluoride, a polyvinylidene fluoride-hexafluoropropylene copolymer, polyethylene oxide, or a combination thereof.

The conductive material ensures conductivity (e.g., electrical conductivity) to the electrode. Any material that does not cause a detrimental chemical change (e.g., does not cause an undesirable chemical change in the rechargeable lithium battery) and conducts electrons can be used in the battery.

Non-limiting examples of the conductive material may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may include a polymer film including polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and the inorganic material may be mixed in one coating layer, or a coating layer including an organic material and a coating layer including an inorganic material may be stacked.

The secondary battery 100 illustrated in FIG. 11 may be a can-type secondary battery made of stainless steel, but the secondary battery is not limited thereto and may include various types of secondary batteries including a prismatic secondary battery made of aluminum.

The case 140 may include a body 120, which includes a accommodation portion S for accommodating an electrode assembly 110, and a flange portion 128 extending around an open end of the accommodation portion S, a cover 130 coupled with the flange portion 128 to seal the open end of the accommodation portion S, and a welded portion 150 disposed on the flange portion 128 and the cover 130 corresponding to the flange portion 128, as described with reference to FIG. 1.

The welded portion 150 may include a first welding bead 220 and a second welding bead 230 having different bonding strengths. In an embodiment, the bonding force of the second welding bead 230 may be less than the bonding force of the first welding bead 220. In an embodiment, the second welding bead 230 may break by a predetermined internal pressure of the sealed accommodation portion S. The configuration of the first welding bead 220 and the second welding bead 230 may be substantially the same as or similar to the configuration of the first welding bead 220 and the second welding bead 230 described with reference to FIGS. 2 to 10b.

The case 140 forms the overall appearance of the secondary battery 100 and may include a conductive metal such as aluminum, an aluminum alloy, or nickel-plated steel. According to an embodiment, the case 140 may include a metallic material such as stainless steel, aluminum, or the like. However, the case 140 may include various metallic materials that satisfy the strength and resistance requirements for external impact required for the secondary battery 100.

According to an embodiment, the body 120 may include a first electrode terminal 122 disposed on one side surface of the body 120 and electrically connected to the first electrode 111, and a second electrode terminal 124 disposed on one side surface of the body 120 and electrically connected to the second electrode 113. The first electrode terminal 122 and the second electrode terminal 124 may be disposed on the same side surface of the body 120. However, the positions of the first and second electrode terminals 122 and 124 are not limited to the positions shown in FIG. 11 and may have various configurations.

According to an embodiment, the case 140 may include an electrolyte solution injection port 126. For example, the electrolyte solution injection port 126 may be a through hole formed on at least one side surface of the case 140. An electrolyte solution is injected into the inside of the case 140 after the body 120 and the cover 130 are joined and sealed. The electrolyte solution injection port 126 may be sealed with a sealing member after the electrolyte solution is injected.

The secondary battery 100 may be a lithium battery cell, a sodium battery cell, etc. However, the scope of the present disclosure is not limited thereto, and the secondary battery 100 includes all batteries that may repeatedly provide electricity by charging and discharging. In an embodiment, if the secondary battery 100 is a lithium battery cell, it may be used in an electric vehicle EV due to favorable life span and efficiency. For example, it may be used in hybrid vehicles such as plug-in hybrid electric vehicles (PHEV). Additionally, lithium battery cells may be used in a wide range of applications requiring power storage, including smartphones, tablet PCs, electric bicycles, and power tools, but is not limited to these examples.

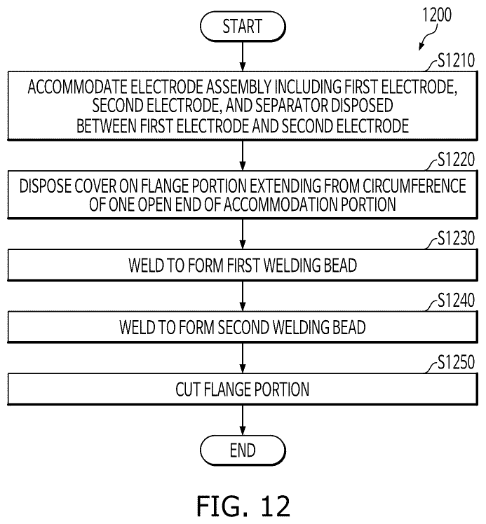

FIG. 12 is a flowchart illustrating a method for manufacturing a secondary battery.

Referring to FIG. 12, a method 1200 for manufacturing a secondary battery includes a step S1210 of accommodating an electrode assembly, which includes a first electrode, a second electrode, and a separator disposed between the first electrode and the second electrode, in an accommodation portion.

A cover may be disposed on a flange portion extending around the open end of the accommodation portion (S1220). For example, referring to FIG. 1, a cover 130 may be disposed on a flange portion 128 extending from an edge of a body 120 to surround the accommodation portion S.

Welding may be performed to form a first welding bead at the welded portion (S1230), and welding may be performed to form a second welding bead (S1240). For example, referring to FIGS. 1 and 2, the second welding bead 230 may be welded separately after welding the remaining portion except for the second welding bead 230. By forming the first welding bead 220 and the second welding bead 230, the body 120 and the cover 130 may form a case 140. Here, the case 140 may include a metallic material. For example, the metallic material may include stainless steel. The flange portion may be cut (S1250).

In the process of welding and joining the body and cover in which the electrode assembly of the secondary battery is accommodated, a vent may be formed by only partially changing the welding pattern.

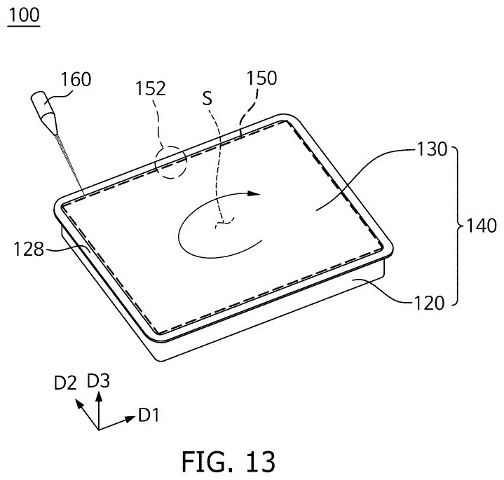

FIG. 13 shows a step of welding a case for a secondary battery.

Referring to FIG. 13, a cover 130 positioned on the upper part of the case 140 to seal the accommodation portion S may be combined with the flange portion 128. The cover 130 may be joined to the flange portion 128 using a welding machine 160. For example, the cover 130 and the flange portion 128 may be joined through laser welding or the like. According to an embodiment, the bonding process may proceed clockwise along a line illustrated in dotted lines in FIG. 13 around the perimeter of the flange portion 128, but the embodiment is not limited to this example.

In an embodiment, the welded portion 150 may be formed through laser welding performed a plurality of times. For example, the remaining part of the welded portion 150 excluding the second welding bead 230 may be welded first to weld the first welding bead 220 illustrated in FIG. 3, and the second welding bead 230 may be welded, thereby forming the welded portion 150 illustrated in FIG. 3. The remaining part of the welded portion 150 excluding the second welding bead 230 is first welded to weld the first welding bead 220 illustrated in FIG. 3, and the second welding bead 230 is welded by adjusting the distance between the welding machine 160 and the secondary battery, thereby forming the second welding bead 230 illustrated in FIG. 3.

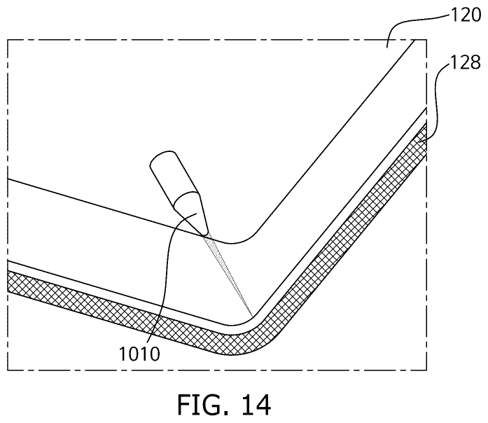

FIG. 14 shows a step of cutting a flange portion.

Referring to FIGS. 13 and 14, after the cover 130 is coupled to the flange portion 128 as described with reference to FIG. 13, the outermost region of the flange portion 128 (i.e., at least a part of the outer region of the welded portion 150) may be cut. According to an embodiment, the flange portion 128 may be cut using a cutting machine 1010. The cutting machine 1010 may be, for example, a laser cutting machine. The flange portion 128 may be cut to an extent extending from the body 120, but the embodiment is not limited to this example.

Although the present disclosure has been described with respect to embodiments thereof, the present disclosure is not limited thereto. Various modifications and variations can be made thereto by those skilled in the art within the spirit of the present disclosure.

1. A case for a secondary battery, comprising:
a body comprising an accommodation portion having an open end and a flange portion extending around the open end;
a cover configured to be coupled to the flange portion to seal the open end; and
a welded portion coupling the flange portion and the cover,
wherein the welded portion comprises a first welding bead and a second welding bead having different bonding forces.

2. The case as claimed in claim 1, wherein a bonding force of the second welding bead is less than a bonding force of the first welding bead.

3. The case as claimed in claim 1, wherein the second welding bead is configured to break upon an internal pressure of the case exceeding a predetermined threshold.

4. The case as claimed in claim 1, wherein a number of the second welding bead is less than a number of the first welding bead.

5. The case as claimed in claim 1, wherein each of the first welding bead and the second welding bead overlaps with an adjacent welding bead.

6. The case as claimed in claim 1, wherein the first welding bead and the second welding bead have an arc geometry, and wherein a central angle of an arc of the second welding bead is less than or equal to a central angle of an arc of the first welding bead.

7. The case as claimed in claim 6, wherein the central angle of the arc of the first welding bead is about 360 degrees, and wherein the central angle of the arc of the second welding bead is about 180 degrees.

8. The case as claimed in claim 7, wherein a radius of the arc of the second welding bead is less than or equal to a radius of the arc of the first welding bead.

9. The case as claimed in claim 7, wherein a radius of the arc of the second welding bead is about 50% of a radius of the arc of the first welding bead.

10. The case as claimed in claim 7, wherein a radius of the arc of the first welding bead is about 0.1 mm, and wherein a radius of the arc of the second welding bead is about 0.05 mm.

11. The case as claimed in claim 7, wherein, based on a direction in which the flange portion and the cover are stacked, a length of the second welding bead is less than a length of the first welding bead.

12. The case as claimed in claim 11, wherein the length of the first welding bead is about 90% to about 100% of a sum of a thickness of the flange portion and a thickness of the cover.

13. The case as claimed in claim 6, wherein both the central angle of the arc of the first welding bead and the central angle of the arc of the second welding bead are about 180 degrees.

14. The case as claimed in claim 13, wherein a radius of the arc of the second welding bead is less than or equal to a radius of the arc of the first welding bead.

15. The case as claimed in claim 13, wherein, based on a direction in which the flange portion and the cover are stacked, a length of the second welding bead is less than a length of the first welding bead.

16. The case as claimed in claim 1, wherein at least one of the body and the cover comprises stainless steel.

17. A secondary battery comprising:
an electrode assembly comprising a first electrode, a second electrode, and a separator disposed between the first electrode and the second electrode; and
a case in which the electrode assembly is accommodated,
wherein the case comprises:
a body comprising an accommodation portion having an open end and a flange portion extending around the open end;
a cover configured to be coupled to the flange portion to seal the open end; and
a welded portion coupling the flange portion and the cover,
wherein the welded portion comprises a first welding bead and a second welding bead having different bonding forces.

18. The secondary battery as claimed in claim 17, wherein a bonding force of the second welding bead is less than a bonding force of the first welding bead.

19. The secondary battery as claimed in claim 17, wherein the body further comprises:
a first electrode terminal disposed on one side surface of the body, the first electrode terminal electrically connected to the first electrode; and
a second electrode terminal disposed on one side surface of the body, the second electrode terminal electrically connected to the second electrode.

20. The secondary battery as claimed in claim 19, wherein the first electrode terminal and the second electrode terminal protrude in a first direction from the accommodation portion,
wherein the flange portion comprises:
a first flange portion extending in the first direction;
a second flange portion and a third flange portion both extending in a second direction perpendicular to the first direction; and
a fourth flange portion extending in a direction opposite to the first direction, and
wherein the second welding bead is formed on the first flange portion, the second flange portion, and the third flange portion.
